(19) United States
(12) Patent Application Publication
(10) Pub. No.: US 2018/0306382 A1
(43) Pub. Date: Oct. 25, 2018

(54) Method for Pressurizing and Melting Cryogenic Solids to Cryogenic Liquids

(71) Applicants: Larry Baxter, Orem, UT (US); Skyler Chamberlain, Provo, UT (US); David Frankman, Provo, UT (US); Aaron Sayre, Spanish Fork, UT (US); Nathan Davis, Bountiful, UT (US)

(72) Inventors: Larry Baxter, Orem, UT (US); Skyler Chamberlain, Provo, UT (US); David Frankman, Provo, UT (US); Aaron Sayre, Spanish Fork, UT (US); Nathan Davis, Bountiful, UT (US)

(21) Appl. No.: 15/491,103

(22) Filed: Apr. 19, 2017

(51) Int. Cl. F17C 7/04; B30B 9/04; B30B 9/12; B30B 9/16; B30B 15/34

(52) U.S. Cl. CPC F17C 7/04; B30B 9/04; B30B 9/12; B30B 9/16; F17C 2250/0636; B30B 15/34; F17C 2223/0161; F17C 2227/0304; B30B 9/121

(57) ABSTRACT

A method for causing a phase change from a cryogenic solid to a cryogenic liquid is disclosed. A melting device, a vessel, and a solids pressurization device are provided. The solids pressurization device passes through at least a portion of the vessel. The cryogenic solid is provided to the vessel with a recycled portion of the cryogenic liquid. The cryogenic solid is conveyed and pressurized towards an outlet of the vessel to a pressure above the triple point by the solids pressurization device. The cryogenic solid is warmed by the melting device to a temperature above the solid-liquid phase transition curve, causing the cryogenic solids to change phase and become the cryogenic liquid.

This invention was made with government support under DE-FE0028697 awarded by The Department of Energy. The government has certain rights in the invention.

### FIELD OF THE INVENTION

This invention relates generally to the field of cryogenic solids handling. More particularly, we are interested in the use desublimating heat exchange as a method for extracting a vapor, like carbon dioxide, as a solid from a carrier gas, such as combustion flue gas.

### BACKGROUND

The ability to strip carbon dioxide and other pollutants from flue gases and other waste gas streams of great importance. One method of stripping these pollutants involves condensing or desublimating the gases into solid form in a cryogenic liquid. At this point, however, solids handling difficulties arise. Even after filtering the cryogenic liquid, the solids are still cold, sublimate quickly, and are problematic for further handling. The ability to simply and economically convert these cryogenic pollutant solids to a liquid for handling is required.

Plastics extrusion involves melting of solid pellets of plastic into a molten plastic and extruding the plastics into a required shape. Plastics extrusion is a mature industry with a variety of extrusions processes. However, this technology has never been applied to cryogenic pressurization and melting of cryogenic solids to cryogenic liquids. Further, plastic recycling is not the same as liquid recycling. Plastic recycling involves the use of used plastics, in solid form, as at least a portion of the solid feed. Nowhere in the process of melting plastics to produce products is the molten plastic recycled to the solids inlet to provide heat to the materials at the inlet.

United States patent publication number 3864927, to Li teaches a method and apparatus for storage, transport, and use of cryogenic gases in solid form. The cryogenic gas is transported by providing it as a cryogenic liquid to a series of closely-packed, gas-tight containers. The cryogenic liquid is then cooled to become a cryogenic solid block. The present disclosure differs from this disclosure in that the cryogenic material is changed from a liquid to a solid. This disclosure is pertinent and may benefit from the methods disclosed herein and is hereby incorporated for reference in its entirety for all that it teaches.

United States patent publication number 7628137, to McAlister teaches a multifuel storage, metering, and ignition system. The storage system has accommodations for cryogenic liquid or cryogenic solid fuels. The cryogenic solid fuel is stored in the tank and is fed by the metering system to the ignition system. The present disclosure differs from this disclosure in that the cryogenic solids are stored in a tank with cryogenic liquids as a slush, and the metered removal of the liquids leads to the melting of the solids to form further liquids. The disclosure has no pressurization to convert the solids to a liquid and is insulated to prevent warming of the solids. This disclosure is pertinent and may benefit from the methods disclosed herein and is hereby incorporated for reference in its entirety for all that it teaches.

United States patent publication number 3354506, to Raley teaches an apparatus for melt extrusion of multi-wall plastic. This typical plastic extruder melts the plastic pellets and uses a screw to pass the material through extruders. The present disclosure differs from this disclosure in that it does not use cryogenic solids or produce cryogenic liquids, and does not recycle the liquid to the inlet to provide a portion of heat to the solids. This disclosure is pertinent and may benefit from the methods disclosed herein and is hereby incorporated for reference in its entirety for all that it teaches.

United States patent publication number 4379525, to Nowicki, et al., teaches a process for recycling plastic container scrap. This involves chopping up used plastics, agitating them in hot water to remove label material, and separating the plastics from the water and label material. The present disclosure differs from this disclosure in that the recycling is reusing solids, not recirculating the liquid form of the solids for heat. This disclosure is pertinent and may benefit from the methods disclosed herein and is hereby incorporated for reference in its entirety for all that it teaches.

### SUMMARY

A method for causing a phase change from a cryogenic solid to a cryogenic liquid is disclosed. A melting device, a vessel, and a solids pressurization device are provided. The solids pressurization device passes through at least a portion of the vessel. The cryogenic solid is provided to the vessel. The cryogenic solid has a pressure-temperature curve, the pressure-temperature curve comprising a triple point and a solid-liquid phase transition curve. A recycled portion of the cryogenic liquid is provided to the vessel, the recycled portion of the cryogenic liquid conveying a portion of heat from the melting device to the cryogenic solid. The cryogenic solid is conveyed and pressurized towards an outlet of the vessel to a pressure above the triple point by the solids pressurization device. The cryogenic solid is warmed by the melting device to a temperature above the solid-liquid phase transition curve, causing the cryogenic solids to change phase and become the cryogenic liquid.

The solids pressurization device may comprise a screw or piston. The screw may comprise a constant pitch or may comprise a decreasing pitch and increasing stem diameter. The screw may comprise a heating element, whereby the screw is the melting device.

The melting device may comprise at least a portion of a pressure vessel having a pressure above the triple point.

The cryogenic liquid may be pressurized to a pressure above a critical point of the cryogenic liquid, producing a supercritical fluid.

The outlet may comprise a restriction. The restriction may comprise a valve, a tapered channel, a compressor, an orifice, or a combination thereof.

The cryogenic solid may comprise carbon dioxide, nitrogen oxide, sulfur dioxide, nitrogen dioxide, sulfur trioxide, hydrogen sulfide, hydrogen cyanide, water, hydrocarbons, mercury, or combinations thereof.

The solids pressurization device may pass through at least a portion of the melting device. The melting device may directly heat the vessel to induce melting.

A portion of a surface of the vessel and a portion of a surface of the solids pressurization device may comprise a material that is inert to the cryogenic liquid. The material may comprise ceramics, stainless steel, polytetrafluoroethylene, polychlorotrifluoroethylene, or combinations thereof.

The melting device may comprise a heat exchanger. The heat exchanger may comprise a shell and tube, plate, plate and frame, plate and shell, spiral, or plate fin style heat exchanger.

The vessel may comprise a temperature sensor, a pressure sensor, or a combination thereof. The vessel may comprise a pressure regulating device, a temperature regulating device, or a combination thereof. A programmable controller may be used to control a feed rate of the cryogenic solids to the vessel, a heating rate of the melting device, and a pressurization rate of the solids pressurization device.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows a method for causing a phase change from a cryogenic solid to a cryogenic liquid.

FIG. 2 shows an isometric cutaway view of a screw compressor pressurization device for causing a phase change from a cryogenic solid to a cryogenic liquid.

FIG. 3 shows an isometric cutaway view of a tapered screw compressor pressurization device for causing a phase change from a cryogenic solid to a cryogenic liquid.

FIGS. 4A-B show an isometric cutaway view of double-screw compressor pressurization device for causing a phase change from a carbon dioxide solid to a carbon dioxide liquid and a pressure-temperature curve for carbon dioxide.

FIGS. 5A-C show a piston pressurization device for causing a phase change from a cryogenic solid to a cryogenic liquid

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention.

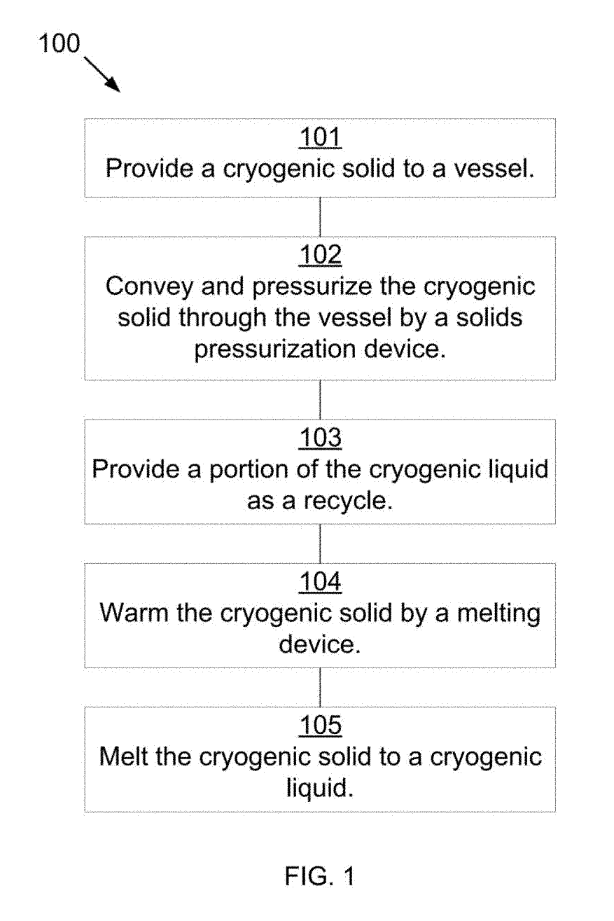

Referring to FIG. 1, a method for causing a phase change from a cryogenic solid to a cryogenic liquid is shown at 100, as per one embodiment of the present invention. A cryogenic solid is provided to a vessel 101. The cryogenic solid is conveyed and pressurized to a pressure above the triple point of the solid through the vessel by a solids pressurization device 102. A recycled portion of the cryogenic liquid is provided to the vessel providing a portion of the heat from the melting device 103. The cryogenic solid is warmed by a melting device to a temperature above the solid-liquid phase transition curve 104. In this manner, the cryogenic solid is melted to a cryogenic liquid 105.

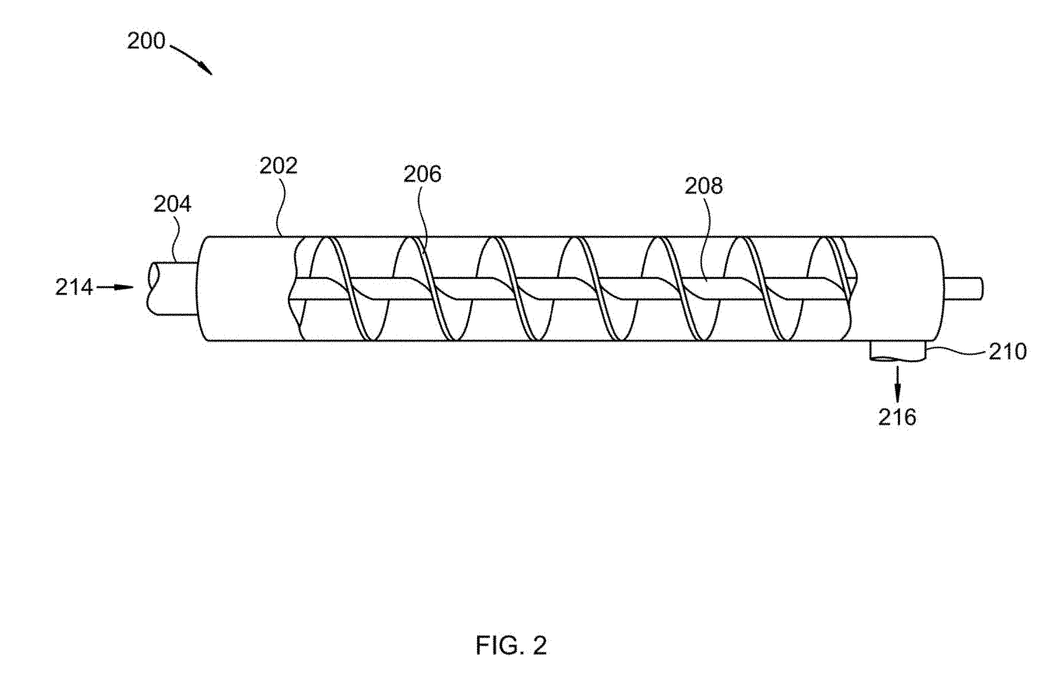

Referring to FIG. 2, an isometric cutaway view of a screw compressor pressurization device for causing a phase change from a cryogenic solid to a cryogenic liquid is shown at 200, as per one embodiment of the present invention. Vessel 202 comprises screw 206. Screw 206 has a constant screw pitch and stem 208 of constant diameter. Vessel 202 further comprises inlet 204 and outlet 210. A cryogenic solid has a pressure-temperature curve with a triple point and a solid-liquid phase transition curve. The cryogenic solid and a recycled portion of a cryogenic liquid are provided as slurry 214 to inlet 204 and are conveyed and pressurized through vessel 202 by screw 206. Slurry 214 is passed through outlet 210 as pressurized cryogenic slurry 216 and provided to a melting device (not shown). The melting device is kept at pressure and heat is provided to pressurized cryogenic slurry 216, causing pressurized cryogenic slurry 216 to melt to become the cryogenic liquid. The cryogenic liquid is passed out of the melting device through an outlet. In some embodiments, the outlet is restricted. In some embodiments, the restriction comprises a valve, a tapered channel, a compressor, an orifice, or a combination thereof.

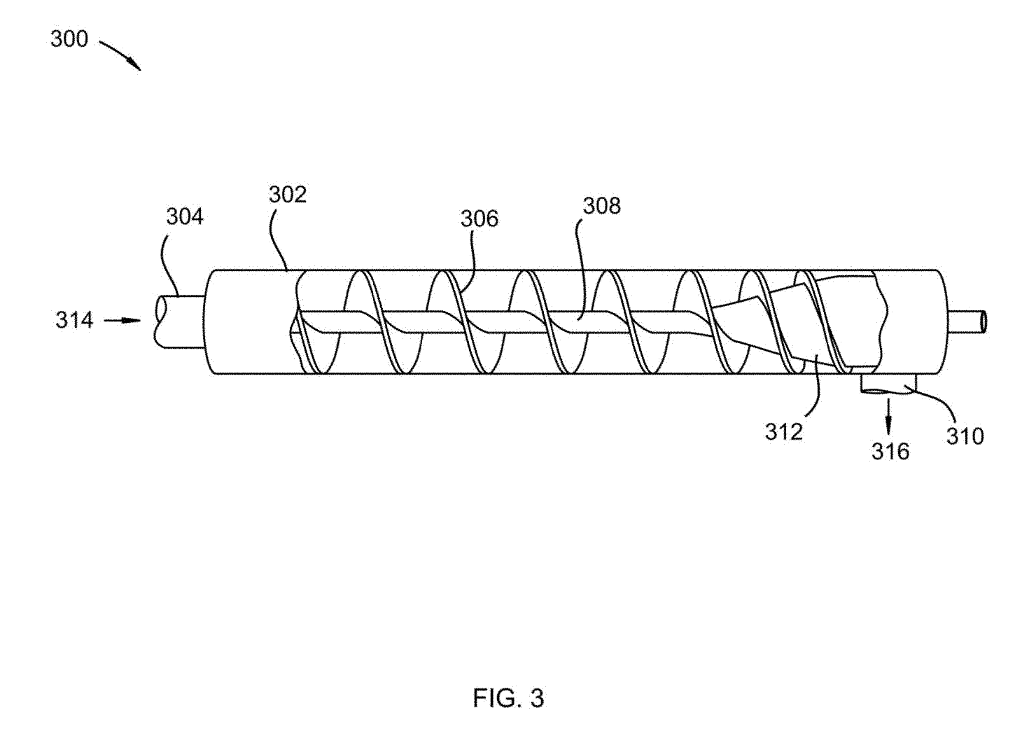

Referring to FIG. 3, an isometric cutaway view of a tapered screw compressor pressurization device for causing a phase change from a cryogenic solid to a cryogenic liquid is shown at 300, as per one embodiment of the present invention. Vessel 302 comprises inlet 304 and outlet 310. Vessel 302 further comprises screw 306. Screw 306 has a greater screw pitch at inlet 304 and a smaller screw pitch near outlet 310, with a thickening of stem 308 near outlet 310. A cryogenic solid has a pressure-temperature curve with a triple point and a solid-liquid phase transition curve. The cryogenic solid and a recycled portion of a cryogenic liquid are provided as slurry 314 to inlet 304 and are conveyed and pressurized through vessel 302 by screw 306. Screw 306 further comprises a heating element that warms cryogenic solid 314 as it is pressurized and converts the cryogenic solid to cryogenic liquid 316 and is passed out of outlet 310. Screw 306, with changing screw pitch and stem diameter, provides the required restriction to maintain pressure in vessel 302. In some embodiments, the heating element in screw 306 comprises an electric heating element or a hot liquid heating tube.

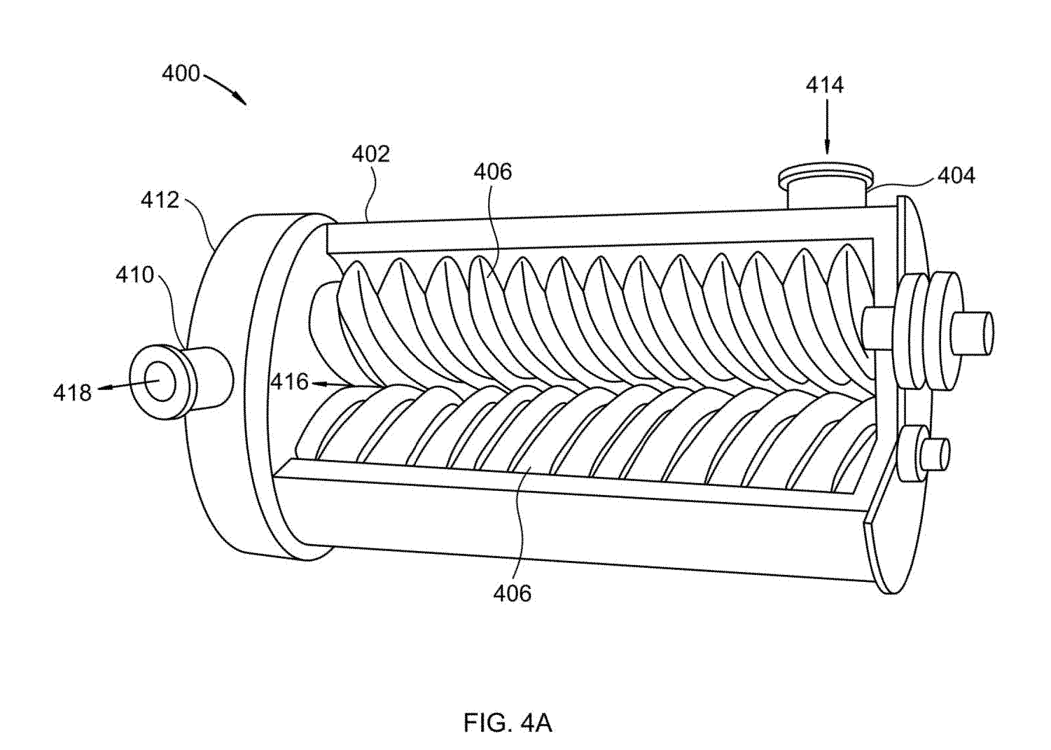

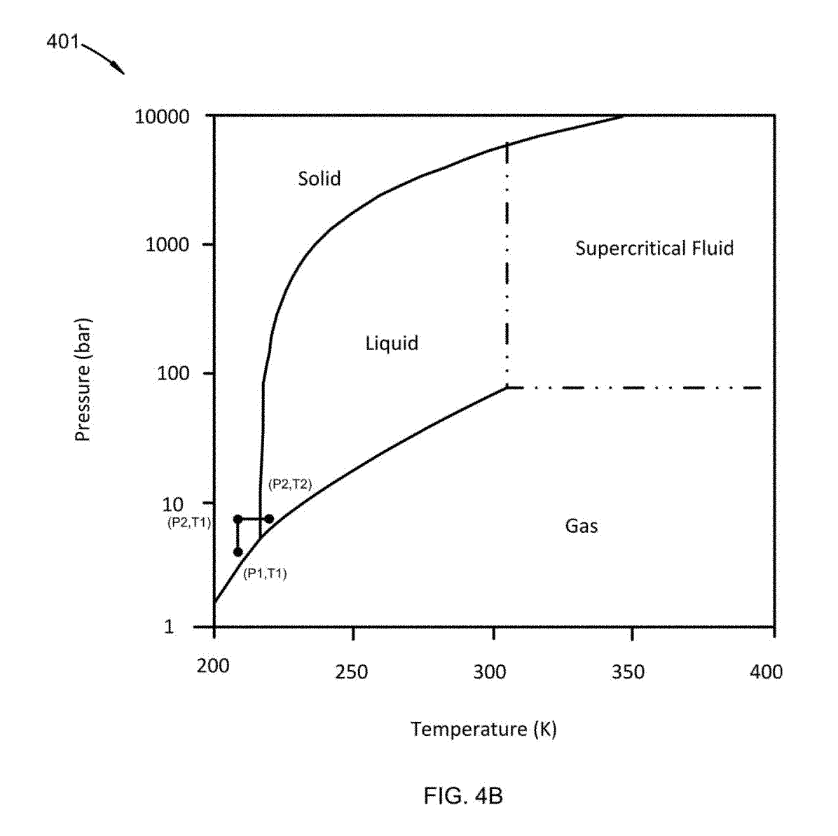

Referring to FIGS. 4A-B, an isometric cutaway view of double-screw compressor pressurization device for causing a phase change from a carbon dioxide solid to a carbon dioxide liquid is shown at 400 and a pressure-temperature curve for carbon dioxide showing the pressure/temperature path is shown at 401, as per one embodiment of the present invention. Vessel 402 comprises screws 406. Screws 406 have a constant screw pitch and a stem of constant diameter. Vessel 402 further comprises inlet 404 and outlet 410. A carbon dioxide solid has a pressure-temperature curve with a triple point and a solid-liquid phase transition curve at 401. The carbon dioxide solid and a recycled portion of a carbon dioxide liquid 418 are provided as slurry 414 to inlet 404 at a first pressure and a first temperature (P1, T1), which is conveyed and pressurized through vessel 402 by screw 406 to a second pressure (P2, T1), becoming pressurized carbon dioxide slurry 416, which is provided to integral melting device 412. Integral melting device 412 is kept at pressure and heat is provided to pressurized carbon dioxide slurry 416, causing the carbon dioxide solid to melt to become carbon dioxide liquid 418. Carbon dioxide liquid 418 is passed out of integral melting device 410 through outlet 410. In some embodiments, outlet 410 is restricted. In some embodiments, the restriction comprises a valve, a tapered channel, a compressor, an orifice, or a combination thereof.

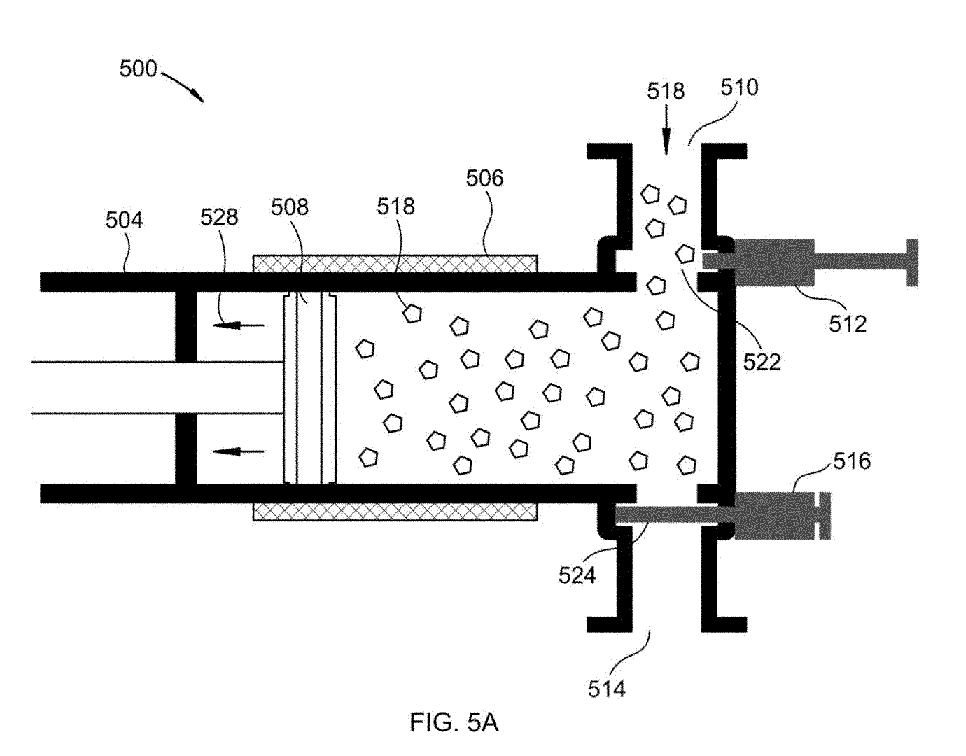

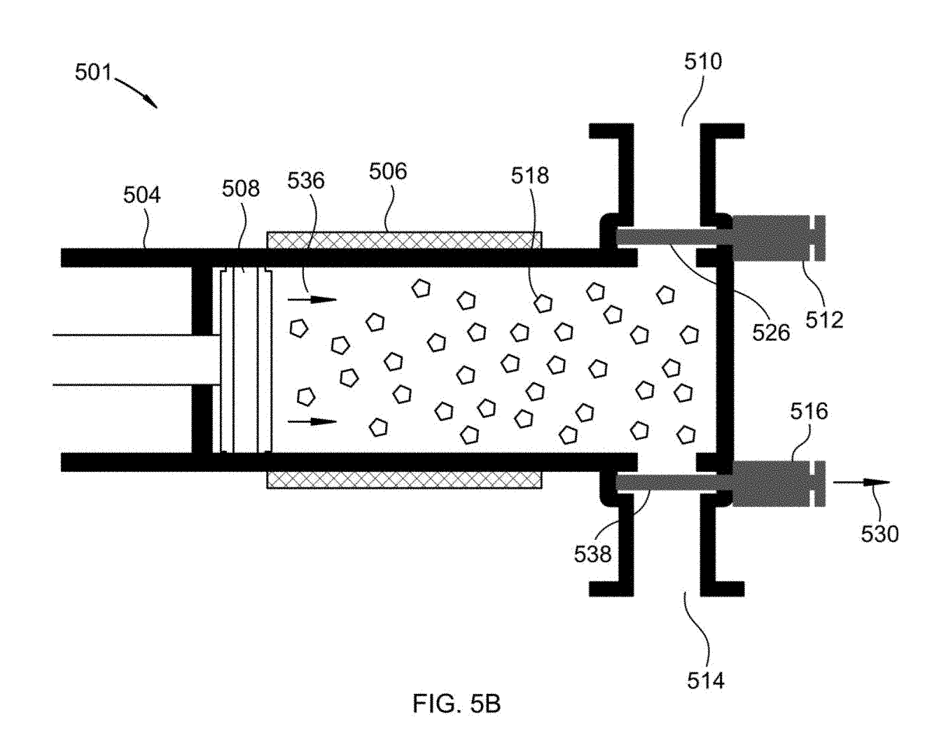

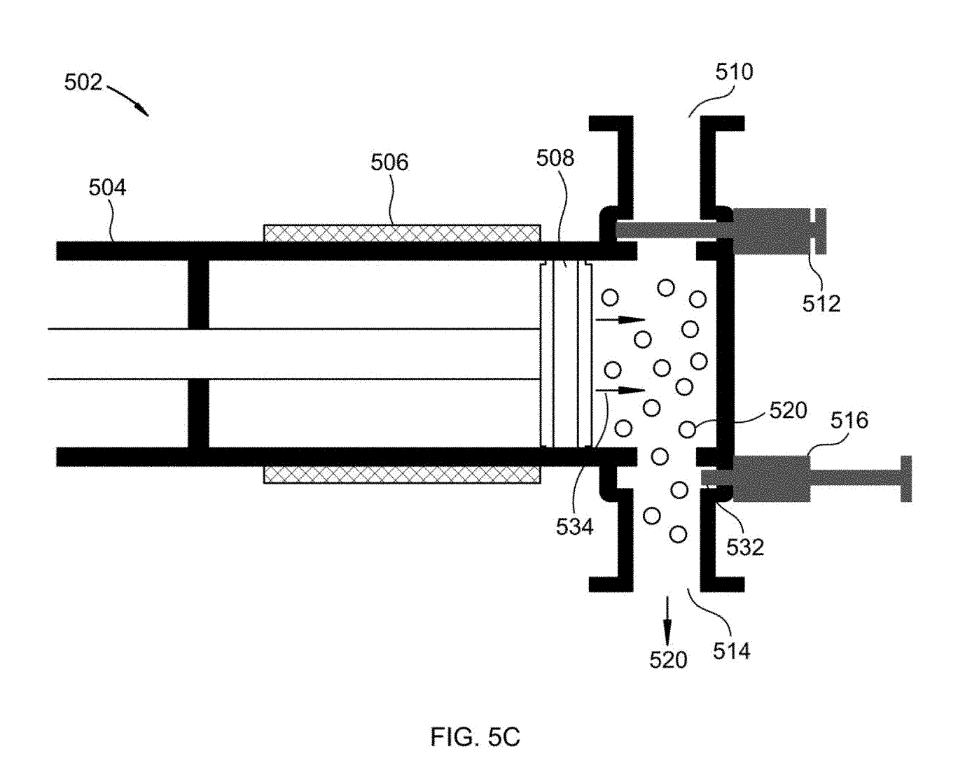

Referring to FIGS. 5A-C, a piston pressurization device for causing a phase change from a cryogenic solid to a cryogenic liquid is shown, with the intake stroke at 500, the beginning of the pressurization and outlet stroke at 501, and the end of the pressurization and outlet stroke at 502, as per one embodiment of the present invention. Piston 504 comprises plunger 508, melting device 506, inlet gate valve 512, outlet gate valve 516, inlet 510, and outlet 514. A cryogenic solid with a recycled portion of cryogenic liquid 520 is provided as slurry 518 to piston 504 while plunger 508 opens 528 through inlet 510 with inlet gate valve 512 in open position 522. Upon completion of opening 528, inlet gate valve 512 closes to closed position 526 and plunger 508 begins closing 536. Melting device 506 provides heat to piston 504, the pressurization by piston 508 and the heat from melting device 506 melting the cryogenic solid to cryogenic liquid 520. As the pressure in piston 504 reaches a set point, outlet gate valve 516 moves from closed position 538 and opens 530 to maintain pressure at the set point until outlet gate valve 516 reaches fully open position 532 and plunger 508 opens 534 fully, causing full removal of cryogenic liquid 520 from piston 504. The cycle is then repeated. The recycled portion of cryogenic liquid 520 provides a portion of heat to the cryogenic solid.

In some instances, the solids pressurization device comprises a screw or piston. In some instances, the screw comprises a constant pitch. In other instances, the screw comprises a decreasing pitch and increasing stem diameter.

In some instances, the screw comprises a heating element, whereby the screw is the melting device. In other instances, the act of compression by the screw provides sufficient heat to melt the solids, whereby the screw itself is the melting device.

In some instances, the melting device is at least a portion of a pressure vessel, the pressure vessel having a pressure above the triple point.

In some instances, the cryogenic liquid is further pressurized to a pressure above a critical point of the cryogenic liquid, producing a supercritical fluid.

In some instances, the outlet comprises a restriction. In some instances, the restriction comprises a valve, a tapered channel, a compressor, an orifice, or a combination thereof.

In some instances, the cryogenic solid comprises carbon dioxide, nitrogen oxide, sulfur dioxide, nitrogen dioxide, sulfur trioxide, hydrogen sulfide, hydrogen cyanide, water, hydrocarbons, mercury, or combinations thereof.

In some instances, the solids pressurization device passes through at least a portion of the melting device. In some instances, the melting device directly heats the vessel to induce melting.

In some instances, a portion of a surface of the vessel and a portion of a surface of the solids pressurization device comprise a material that is inert to the cryogenic liquid. In some instances, the material comprises ceramics, stainless steel, polytetrafluoroethylene, polychlorotrifluoroethylene, or combinations thereof.

In some instances, the melting device comprises a heat exchanger. In some instances, the heat exchanger comprises a shell and tube, plate, plate and frame, plate and shell, spiral, or plate fin style heat exchanger.

In some instances, the vessel further comprising a temperature sensor, a pressure sensor, or a combination thereof. In some instances, a pressure regulating device, a temperature regulating device, or a combination thereof are provided. In some instances, a programmable controller is provided to control a feed rate of the cryogenic solids to the vessel, a heating rate of the melting device, and a pressurization rate of the solids pressurization device.

Combustion flue gas consists of the exhaust gas from a fireplace, oven, furnace, boiler, steam generator, or other combustor. The combustion fuel sources include coal, hydrocarbons, and bio-mass. Combustion flue gas varies greatly in composition depending on the method of combustion and the source of fuel. Combustion in pure oxygen produces little to no nitrogen in the flue gas. Combustion using air leads to the majority of the flue gas consisting of nitrogen. The non-nitrogen flue gas consists of mostly carbon dioxide, water, and sometimes unconsumed oxygen. Small amounts of carbon monoxide, nitrogen oxides, sulfur dioxide, hydrogen sulfide, and trace amounts of hundreds of other chemicals are present, depending on the source. Entrained dust and soot will also be present in all combustion flue gas streams. The method disclosed applies to any combustion flue gases. Dried combustion flue gas has had the water removed.

Syngas consists of hydrogen, carbon monoxide, and carbon dioxide.

Producer gas consists of a fuel gas manufactured from materials such as coal, wood, or syngas. It consists mostly of carbon monoxide, with tars and carbon dioxide present as well.

Steam reforming is the process of producing hydrogen, carbon monoxide, and other compounds from hydrocarbon fuels, including natural gas. The steam reforming gas referred to herein consists primarily of carbon monoxide and hydrogen, with varying amounts of carbon dioxide and water.

Light gases include gases with higher volatility than water, including hydrogen, helium, carbon dioxide, nitrogen, and oxygen. This list is for example only and should not be implied to constitute a limitation as to the viability of other gases in the process. A person of skill in the art would be able to evaluate any gas as to whether it has higher volatility than water.

Refinery off-gases comprise gases produced by refining precious metals, such as gold and silver. These off-gases tend to contain significant amounts of mercury and other metals.

1. A method for causing a phase change from a cryogenic solid to a cryogenic liquid comprising:
providing a melting device, a vessel, and a solids pressurization device, wherein the solids pressurization device passes through at least a portion of the vessel;
providing the cryogenic solid to the vessel, the cryogenic solid having a pressure-temperature curve, the pressure-temperature curve comprising a triple point and a solid-liquid phase transition curve;
providing a recycled portion of the cryogenic liquid to the vessel, the recycled portion of the cryogenic liquid conveying a portion of heat from the melting device to the cryogenic solid;
conveying and pressurizing the cryogenic solid towards an outlet of the vessel to a pressure above the triple point by the solids pressurization device; and,
warming the cryogenic solid by the melting device to a temperature above the solid-liquid phase transition curve, causing the cryogenic solids to change phase and become the cryogenic liquid.

2. The method of claim 1, providing the solids pressurization device comprising a screw or piston.

3. The method of claim 2, providing the screw comprising a constant pitch.

4. The method of claim 2, providing the screw comprising a decreasing pitch and increasing stem diameter.

5. The method of claim 2, providing the screw comprising a heating element, whereby the screw is the melting device.

6. The method of claim 1, providing the melting device as at least a portion of a pressure vessel, the pressure vessel having a pressure above the triple point.

7. The method of claim 1, further comprising pressurizing the cryogenic liquid to a pressure above a critical point of the cryogenic liquid, producing a supercritical fluid.

8. The method of claim 1, providing the outlet with a restriction.

9. The method of claim 8, providing the restriction comprising a valve, a tapered channel, a compressor, an orifice, or a combination thereof.

10. The method of claim 1, providing the cryogenic solid comprising carbon dioxide, nitrogen oxide, sulfur dioxide, nitrogen dioxide, sulfur trioxide, hydrogen sulfide, hydrogen cyanide, water, hydrocarbons, mercury, or combinations thereof.

11. The method of claim 1, providing the solids pressurization device passing through at least a portion of the melting device.

12. The method of claim 1, providing the melting device directly heating the vessel to induce melting.

13. The method of claim 1, further comprising providing a portion of a surface of the vessel and a portion of a surface of the solids pressurization device comprising a material that is inert to the cryogenic liquid.

14. The method of claim 13, providing the material comprising ceramics, stainless steel, polytetrafluoroethylene, polychlorotrifluoroethylene, or combinations thereof.

15. The method of claim 1, providing the melting device comprising a heat exchanger.

16. The method of claim 15, providing the heat exchanger comprising a shell and tube, plate, plate and frame, plate and shell, spiral, or plate fin style heat exchanger.

17. The method of claim 1, providing the vessel further comprising a temperature sensor, a pressure sensor, or a combination thereof.

18. The method of claim 17, providing the vessel further comprising a pressure regulating device, a temperature regulating device, or a combination thereof.

19. The method of claim 18, further comprising providing a programmable controller to control a feed rate of the cryogenic solids to the vessel, a heating rate of the melting device, and a pressurization rate of the solids pressurization device.

20. The method of claim 1, wherein the providing the recycled portion of the cryogenic liquid step is accomplished by passing the recycled portion of the cryogenic liquid through a pre-heater before providing the recycled portion of the cryogenic liquid to the vessel.
